(19) United States
(12) Patent Application Publication
(10) Pub. No.: US 2007/0080852 A1
(43) Pub. Date: Apr. 12, 2007

(54) Phase locked loop as linear chirp extender

(76) Inventors: Joel C. Blumke, Tucson, AZ (US); Ralston S. Robertson, Northridge, CA (US); David W. Baker, Tucson, AZ (US); Lowell Rathbun, Portland, OR (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/245,854

(22) Filed: Oct. 7, 2005

(51) Int. Cl. G01S 13/08

(52) U.S. Cl. 342/103; 342/132; 342/134

(57) ABSTRACT

Disclosed is a system and method for widening base linear chirp signals from a first bandwidth to a larger second bandwidth while controlling the proliferation of spurious (unwanted) signals. One aspect of the invention provides for using a phase locked loop (PLL) for generating an output signal having a greater bandwidth than the bandwidth associated with the chirp signal. The PLL effectively tracks a reference signal generated at least in part by the chirp source to reduce spurious signals in the output signal. Another aspect of the invention is to use a common local oscillator in the signal transmit and receive paths to cancel consistent phase non-linearity's.

### TECHNICAL FIELD

The present invention relates generally to signal processing in radar systems and more particularly to a system and method for widening base linear chirp signals from a first bandwidth to a larger second bandwidth while controlling the proliferation of spurious (unwanted) signals.

### BACKGROUND OF THE INVENTION

In recent years, the U.S. military has systematically moved from conventional weaponry and laser guided weaponry to weaponry utilizing global positioning satellites (GPS). The robustness of GPS-type systems, which confers all weather accuracy in wholly autonomous weapons, has promulgated this change. To fully exploit the potential of GPS guided bombs, a sensor is generally required with matching all weather capability and standoff range. One type of sensor that meets these criteria is the high resolution imaging Synthetic Aperture Radar (SAR), which may also be capable of Ground Moving Target Indication (GMTI).

Modern high-performance radar systems often generate signals of extraordinarily wide bandwidth. For example, the General Atomics Lynx Synthetic Aperture Radar (SAR) employs a Linear-FM (LFM) chirp waveform and can operate over 3 GHz bandwidth at a 16.7 GHz center frequency. Furthermore, maximum exploitation of these radar signals requires the generated waveforms to be of very high quality, possessing exceptional spectral purity. With such radar signals, SAR spot imaging can be performed with resolutions as fine as several inches at tens of nautical miles, cutting through any weather. Likewise, GMTI capabilities in such radar signals range, for example, from the detection of vehicles to the recognition of rotating radar antennas, vehicle types and hovering helicopters.

Military aircrafts are currently being equipped with such radars in order to provide increased safety to military personnel and assets, as well as increased operational capabilities. The GPS-type systems confer the ability to attack multiple separate targets with laser guided bomb-like accuracy in all weather single pass attacks. There is no need for the aircraft to wait around directing the laser at the target until detonation, as the GPS-type weapons are completely autonomous once fired.

In operation, a SAR generally emits a series of chirp signals. A chirp signal is a frequency modulated signal having a linear frequency change versus time characteristic. The chirp signals generally originate from a precision device that operates in a frequency range much lower than currently desired for most SAR applications (e.g., less than 500 MHz). In order to extend this frequency range to a more desirable range, a number of techniques have been used in the past. The most common technique involves direct frequency multiplication of the base linear chirp signal to widen the bandwidth. A problem with this method is that the multiply chain is not frequency selective and therefore multiplies the in-band, as well as, the out-of-band spurious signals, which creates multiple signal frequencies in the band of interest. Another method for achieving high range resolution is to post process several smaller bandwidth chirps to achieve the necessary bandwidth. Problems associated with this method include cost, and substantial amounts of hardware for implementation.

In view of the aforementioned shortcomings associated with widening a base linear chirp to cover a greater bandwidth, there is a strong need in the art for a versatile and low cost linear chirp extender that can also control the proliferation of spurious (unwanted) signals.

Although the present background describes the functionality and limitations of synthetic aperture radar systems or a particular class of communications, such description is merely provided to exemplify a problem capable of resolution with the present invention. Any discussion herein directed to specific radars or communications protocols should not be taken by those skilled in the art as a limitation on the applicability of the invention described herein.

### SUMMARY OF THE INVENTION

The present invention relates to a system and method for widening a base linear chirp signal to cover a larger bandwidth than the source of the chirp signal while, at the same time, controlling spurious signals.

One aspect of the present invention relates to a linear chirp extender apparatus comprising: a local oscillator including a chirp source for producing a chirp signal having a first bandwidth and a phase locked loop (PLL) communicatively coupled to the chirp source, wherein the PLL generates a local oscillator signal having reduced spurious signals for use in a transmit signal path and a receive signal path, wherein common errors in transmitted and local oscillator signals are canceled in the receive signal path.

Another aspect of the present invention relates to a method for extending a linear chirp signal, the method comprising: receiving a chirp signal from a chirp source, wherein the chirp signal has a first bandwidth; communicatively coupling the chip source to a phase-locked loop (PLL) for generating a local oscillator signal having reduced spurious signals; transmitting an output signal including at least a portion of the local oscillator signal; receiving the output signal reflected from an associated target; and mixing the reflected output signal with the local oscillator signal in order to cancel errors common to both transmitted and local oscillator signals.

Another aspect of the present invention relates to a system for transmitting and receiving an extended chirp signal, the system comprising: a chirp source for producing a chirp signal having a first bandwidth; a phase locked loop (PLL) communicatively coupled to the chirp source, the PLL including a phase detector and voltage controlled oscillator (VCO), wherein the PLL generates a local oscillator signal; a receiver for receiving signals reflected from an associated target; a mixer communicatively coupled to the receiver and the local oscillator signal in order to cancel errors common to both transmitted and local oscillator signals.

Another aspect of the present invention relates to a linear chirp extender apparatus including: a chirp source for producing a chirp signal having a first bandwidth; a phase locked loop (PLL) communicatively coupled to the chirp source, the PLL including a phase detector and voltage controlled oscillator (VCO), wherein the PLL generates an output signal having a greater bandwidth than the first bandwidth associated with the chirp signal and the PLL tracks a reference signal generated at least in part by the chirp source to reduce spurious signals in the output signal.

Another aspect of the present invention relates to a method for extending a linear chirp signal, the method including: receiving a chirp signal from a chirp source, wherein the chirp signal has a first bandwidth; communicatively coupling the chip source to a phase-locked loop (PLL) for generating an output signal having a greater bandwidth than the first bandwidth associated with the chirp signal and tracking a reference signal generated at least in part by the chirp source to reduce spurious signals in the output signal.

Another aspect of the present invention relates to a system for transmitting and receiving a chirp signal, the system including: a chirp source for producing a chirp signal having a first bandwidth; a phase locked loop (PLL) communicatively coupled to the chirp source, the PLL including a phase detector and voltage controlled oscillator (VCO), wherein the PLL generates an output signal having a greater bandwidth than the first bandwidth associated with the chirp signal and the PLL tracks a reference signal generated at least in part by the chirp source to reduce spurious signals; a receiver for receiving signals reflected from an associated target; and a local oscillator communicatively coupled to the PLL and the receiver for canceling phase errors.

The foregoing and other features of the invention are hereinafter more fully described and particularly pointed out in the claims, the following description and the annexed drawings setting forth in detail illustrative embodiments of the invention, such being indicative, however, of but a few of the various ways in which the principles of the invention may be employed.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exemplary system block diagram in accordance aspects of the present invention.

FIG. 2 is a flow chart of an exemplary method for extending a linear chirp signal in accordance with one aspect of the present invention.

### DETAILED DESCRIPTION

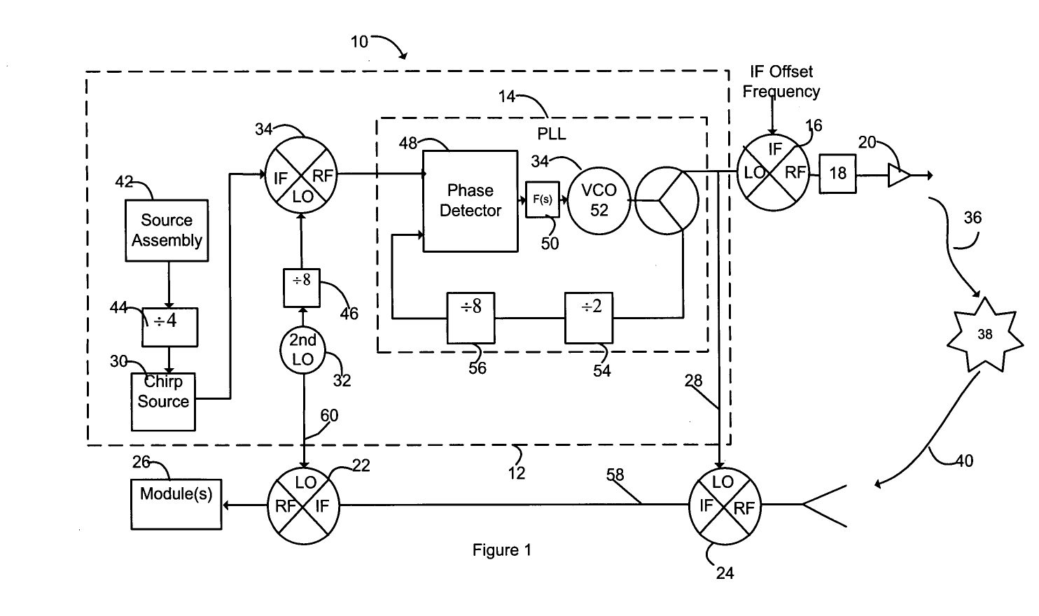

Referring now to FIG. 1, a block diagram of an exemplary linear chirp extender system 10 in accordance with aspects of the invention is illustrated. The system 10 generally includes a transmit signal path and a receive signal path. The transmit signal path may include a local oscillator (identified in broken line) 12, a phase-locked loop 14, a mixer 16, a filter 18 and an amplifier 20. The receive signal path may include one or more mixers 22, 24 and one or more processing modules 26. One of ordinary skill in the art will readily appreciate that the transmit and receive signal paths may also include one or more oscillators, mixers, frequency/phase divider circuits and/or additional amplifiers (not shown) for processing of the transmitted and/or received signal.

As illustrated, in FIG. 1, the transmit signal path and the receive signal paths include at least one common local oscillator signal 28. The local oscillator signal 28 effectively acts to cancel consistent phase non-linearity's present in both the transmitted and received signals. The effect of such cancellation is to remove common errors in the transmitted signal and local oscillator signals in the receive signal path.

The local oscillator 12 generally includes a chirp source 30, a second local oscillator 32, a mixer 34, and the PLL 14. As discussed in more detail below, the chirp source 30 generally generates a chirp signal within a predetermined frequency range (or bandwidth). The chirp signal is bandwidth and frequency extended by the PLL 14 for use in a SAR or other radar systems and transmitted. The PLL 14 effectively multiplies the chirp signal and generates an output signal having a greater bandwidth than the bandwidth associated with the chirp signal. In addition, the PLL 14 tracks a reference signal generated at least in part by the chirp source to reduce spurious signals in the output signal 36. The transmitted output signal 36 is generally reflected off a target 38 and received by the system 10. The received signal 40 may then be operated on (e.g., divided) and transmitted to one or more modules 26 for further processing. Since the received signal and the transmitted signal have local oscillator signal 28 in common, consistent phase non-linearities for both transmit and receive signals are generally cancelled.

The chirp source 30 may be any signal source that is capable of generating at least one high quality signal. The chirp source 30 is generally capable of automated sweeping based throughout a predefined frequency range based on predetermined or user defined intervals (or steps). Such functionality allows the chirp source 30 to generate linear frequency-swept signals for chirped radar or other applications over a predetermined frequency range (or bandwidth).

In one embodiment, the chirp source 30 is a direct digital synthesizer (DDS). The chirp source 30 may directly generate frequencies up to 400+megahertz when driven at a 1 gigahertz internal clock speed. The chirp source 30 is generally capable of generating precision frequency signals with high frequency resolution, fast frequency hopping, fast settling time, automated frequency sweeping capabilities, and low noise (e.g., less than −140 dBc/Hz).

As shown in FIG. 1, the chirp source 30 has at least one input and one output. The input for the chirp source 30 is generally dependent on the particular chirp source 30 used. When in the form of a DDS, as shown in FIG. 1, the input signal may originate from a source assembly 42 having, for example, an output frequency of approximately 4.0 gigahertz. The output of the source assembly 42 may be divided to a desired frequency (e.g., 1.0 gigahertz) by a frequency divider circuit 44, which may be received by the chirp source 12. One of ordinary skill in the art will readily appreciate that any conventional clock or reference source may be used as an input source to the chirp source 30.

As stated above, the output of the chirp source 30 may be one or a series of time varying signals. In one embodiment, the output of the chirp source 30 may be a linear time varying signal having a frequency range within about 100-500 megahertz, and more preferably within an operable frequency range of about 181-331 megahertz, with a center frequency of about 256 megahertz. The chirp source 30 may vary the chirp signal in any manner (e.g., automatically, manually, through hardware or software, etc.). In one embodiment, the chirp source 30 varies the frequency of the chirp signal by a user defined interval (e.g., 1 Hz, 5 MHz, etc.) from one chirp signal to the next chirp signal over the desired frequency spectrum (or bandwidth). One of ordinary skill in the art will readily appreciate that there are a variety of ways to provide a time varying linear chirp signal, and that all such techniques should be considered to fall within the scope of the present invention.

The output of the chirp source 30 may be coupled to mixer 34 along with the output from the second local oscillator 32. Generally, the chirp signal is mixed onto the output of the second local oscillator 32 to form a radio frequency (RF) output signal. The second local oscillator 32 may output a signal having any desired frequency. For example, the second local oscillator 32 may be a fixed 7.25 gigahertz oscillator, an output controllable oscillator, etc. As shown in FIG. 1, the output signal from the second local oscillator 32 may be divided by a frequency divider circuit 46 (e.g., a divide by 8 circuit), so that the mixer 34 receives a signal having a frequency of approximately 906.25 megahertz.

The mixer 34 combines the signals received (e.g., the output of the chirp source 30 and the divided output of the second local oscillator 32) and generates an RF output signal within a frequency range of about 1.087 to 1.237 gigahertz having a center frequency of about 1.162 gigahertz. The RF output signal may be selected to allow for various design considerations. For example, depending on the desired output signal, components may be selected that minimize costs, enable tracking of fast chirps, etc.

The RF output signal may be input to the PLL 14. Alternatively, the chirp source 30 may be directly input to the PLL 18. The PLL 14 functions both as a multiplier and tracking filter to achieve a very wideband linear output chirp signal without the associated spurious signals. The PLL 14 generally includes a phase detector 48, a loop filter 50, a voltage controllable oscillator (VCO) 52 and one or more frequency divider circuits 54 (e.g., divide by 2 circuit), 56 (e.g., divide by 8 circuit). The phase detector 48 is operable to receive the RF output signal from the mixer 34 (also referred to herein as a reference signal) as one input to the phase detector 48. The phase detector 48 can be any type of phase detector that is capable of detecting phase differences between two or more received signals. In one embodiment, the phase detector 48 is capable of receiving two input signals and detecting a difference in the phase associated with the two input signals. One exemplary phase detector 48 is a digital phase frequency phase detector manufactured from Hittite Microwave Corporation of Chelmsford, Mass. as part no. HMC439QS16G.

The output from the phase detector 48 may be input through a loop filter 50 and used as a control signal to the VCO 52. The control signal output from the phase detector 48 to the VCO 52 generally controls the frequency of the output signal generated by the VCO 52. The loop filter 50 may be any type of filter that outputs the desired control signals (e.g., frequency dependent (active) filter, non-frequency dependent (passive) filter, etc.) to the VCO 52. The VCO 52 typically generates an output signal within a predefined range (e.g., within the range of about 13.5 to 20.0 gigahertz). Preferably, the VCO 52 has an operable frequency range of about 17.4 to 19.8 gigahertz with a center frequency of about 18.6 gigahertz. The output of the VCO 52 generally corresponds to the control signal and performs a multiplication operation on the received reference signal. The multiplication operation effectively extends the linear range of chirp source 30. In one embodiment, the VCO 52 is a VCO manufactured by Sivers IMA KB of Sweden, under part number VO3262P.

The output signal of the VCO 52 is generally transmitted for use by an application (e.g., SAR, GMTI, etc.), used in the receive signal path to cancel phase and frequency errors, and/or processed further. The output signal of the VCO 52 may also be fed-back to one of the inputs to the phase detector 48, as shown in FIG. 1. Generally, the signal fed-back to the phase detector 48 is divided depending on the available frequency and/or phase input range for the phase detector 48. The frequency divider circuits 54, 56 are generally included in the feedback loop from the VCO 52 to a second input of the phase detector 48. The value of the frequency divider circuits is generally determined based on design considerations of the PLL 14 (e.g. the multiplication factor). The feedback signal effectively provides the PLL 14 a tracking mechanism for generating a phase-locked loop output signal from the VCO 52 that varies linearly in relation to the received reference signal. As shown in FIG. 1, the output signal of the VCO 52 may also divided by frequency divider circuits 54 (e.g., a divide by 2) and 56 (e.g., a divide by 8).

In operation, as the chirp source 30 ramps through a desired frequency range (or bandwidth) from about 181 megahertz to about 331 megahertz at a predetermined interval (e.g., 1 Hz, 5.0 MHz, etc.), the VCO 52 generates a corresponding signal that varies linearly in relation to the chirp signal within the frequency range of about 17.4 to 19.8 gigahertz, thereby extending the linear chirp signal from about 181-331 megahertz to about 17.4 to 19.8 gigahertz. As the chirp source 30 sweeps through the desired frequency range, the divided output of the VCO 52 is fed-back to the phase detector 48, so as to phase lock the output of the VCO 52 to the reference signal.

As further shown in FIG. 1, the local oscillator signal 28 is also routed to mixer 16. Mixer 16 includes two inputs, the local oscillator signal 28 and the first intermediate offset frequency. The intermediate offset frequency typically originates from the source assembly 42. The output of the mixer is input through filter 18 (e.g., a band pass filter) and transmitted through amplifier 20 to an associated target 38. Generally the target 38 is a ground based target, but air based targets are also within the scope of the present invention. The reflected signal 40 is received by the system 10. The reflected signal 40 is routed to mixer 24 where the local oscillator signal 28 is used to extract the intermediate frequency signal from the reflected RF signal 40. An intermediate frequency signal 58 may then be routed to another mixer 22 for additional processing. For example, as shown in FIG. 1, the mixer 22 includes two inputs, the second local oscillator signal 60 and the intermediate frequency signal 58. The mixer can provide any desired operation on the input signals (e.g., addition, subtraction, etc.). The output of the mixer 22 may be a radio frequency signal that may be processed by one or more modules 26. By utilizing the PLL and the local oscillator signals in both the receive and transmit paths, common phase and frequency errors in transmitted signal and local oscillator signals are canceled in the received signal path at the mixer 24.

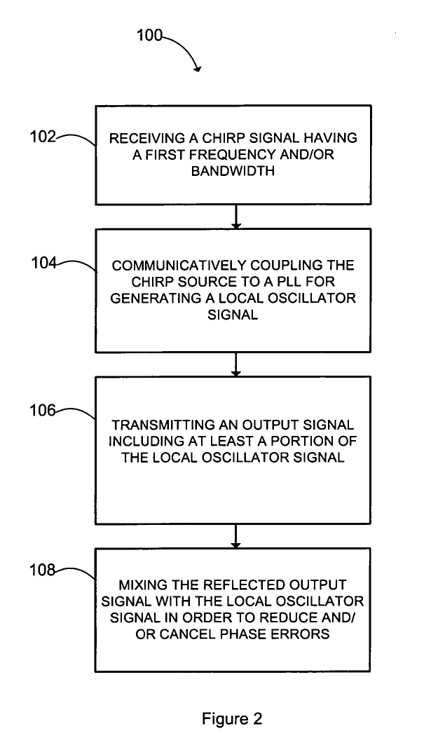

Referring to FIG. 2, an exemplary method 100 for extending the linear chirp frequency is illustrated. The method generally includes the step 102 of receiving a chirp signal having a first frequency and/or bandwidth. The step 104 includes communicatively coupling the chirp source to a PLL for generating a local oscillator signal. The step 106 includes transmitting an output signal including at least a portion of the local oscillator signal. The step 108 includes mixing the reflected output signal with the local oscillator signal in order to reduce and/or cancel phase errors.

The disclosed system and method effectively up-converts a baseband signal (e.g., a chirp signal) and utilizes a phase locked loop as a multiplier and tracking filter to achieve a very wideband linear output chirp without the associated spurious signals. Preferably, the spurious signals are controlled to a level of −50 dBc or less.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A linear chirp extender apparatus comprising:
a local oscillator including a chirp source for producing a chirp signal having a first bandwidth and a phase locked loop (PLL) communicatively coupled to the chirp source, wherein the PLL generates a local oscillator signal having reduced spurious signals for use in a transmit signal path and a receive signal path, wherein common errors in transmitted and local oscillator signals are canceled in the receive signal path.

2. The apparatus of claim 1, wherein the local oscillator signal has a greater bandwidth than the first bandwidth associated with the chirp signal.

3. The apparatus of claim 1, wherein the chirp source is a direct digital synthesizer.

4. The apparatus of claim 1, wherein the PLL includes a phase detector and a voltage controlled oscillator (VCO).

5. The apparatus of claim 4, wherein the PLL tracks a reference signal generated at least in part by the chirp source.

6. The apparatus of claim 5, wherein the reference signal is generated from combining the chirp signal with an oscillator output signal to form at least a first input to the phase detector.

7. The apparatus of claim 6, wherein a second input to the phase detector is communicatively coupled to the VCO output signal.

8. The apparatus of claim 7, wherein the VCO output signal is divided with at least one frequency divider circuit to form a feedback signal for input to the second input of the phase detector.

9. The apparatus of claim 8, wherein a control signal is generated based upon inputs received by the first input and the second input of the phase detector.

10. The apparatus of claim 9, wherein the control signal corresponds to a physical difference between the first and second phase detector input signals.

11. The apparatus of claim 10, wherein the local oscillator signal corresponds to the control signal.

12. The apparatus of claim 1, wherein a mixer receives and combines a local oscillator signal and an offset frequency for transmission.

13. The apparatus of claim 1, wherein the local oscillator signal has a spurious signal component of about less than −50 dBc.

14. The apparatus of claim 1, wherein the local oscillator signal corresponds to a selective multiplication of the chirp signal.

15. A method for extending a linear chirp signal, the method comprising:
receiving a chirp signal from a chirp source, wherein the chirp signal has a first bandwidth;
communicatively coupling the chip source to a phase-locked loop (PLL) for generating a local oscillator signal having reduced spurious signals;
transmitting an output signal including at least a portion of the local oscillator signal;
receiving the output signal reflected from an associated target; and
mixing the reflected output signal with the local oscillator signal in order to cancel errors common to both transmitted and local oscillator signals.

16. A system for transmitting and receiving an extended chirp signal, the system comprising:
a chirp source for producing a chirp signal having a first bandwidth;
a phase locked loop (PLL) communicatively coupled to the chirp source, the PLL including a phase detector and voltage controlled oscillator (VCO), wherein the PLL generates a local oscillator signal;
a receiver for receiving signals reflected from an associated target;
a mixer communicatively coupled to the receiver and the local oscillator signal in order to cancel errors common to both transmitted and local oscillator signals.

17. The system of claim 16, wherein the reference signal includes at least a portion of the chirp signal. .

18. The system of claim 16, wherein a mixer forms the reference signal by combining the chirp signal with an oscillator output signal from the local oscillator to form at least one input to the phase detector.

19. The system of claim 18, wherein a mixer forms a received chirp signal by subtracting the oscillator output signal from the received signals.

20. The system of claim 19, wherein at least a portion of the received chirp signal is viewable on a radar display.
